(19) United States
(12) Patent Application Publication
(10) Pub. No.: US 2023/0383703 A1
(43) Pub. Date: Nov. 30, 2023

(54) MULTI-FUEL SYSTEM AND METHOD FOR MANAGING PERFORMANCE

(71) Applicant: Hyliion Inc., Cedar Park, TX (US)

(72) Inventors: Jay Kevin Neutzler, Austin, TX (US); Patrick Sexton, Austin, TX (US)

(21) Appl. No.: 18/319,061

(22) Filed: May 17, 2023

Related U.S. Application Data
(60) Provisional application No. 63/346,631, filed on May 27, 2022.

(51) Int. Cl. F02D 19/08; B60K 15/077

(52) U.S. Cl. CPC F02D 19/081; B60K 15/077; B60K 2015/03144

(57) ABSTRACT

A multi-fuel system and a method for supplying one or more fuels to an engine in a vehicle having a multi-fuel system are disclosed. Embodiments may determine a quantity of fuel added to one or more tanks, determine energy content and a mass property for each fuel stored in the tanks and supply one or more fuels from the tanks to achieve an operating parameter of the vehicle. Embodiments may analyze a route and determine, for a segment on the route, whether to supply a first fuel with a first set of characteristics or supply a second fuel with a second set of characteristics. The selection of a single fuel or a mixture of two or more fuels for a segment may be based on cost and/or characteristics related to emissions or power.

### PRIORITY CLAIM

This application claims priority under 35 U.S.C. § 119(e) to U.S. Provisional Application No. 63/346,631, filed May 27, 2022, the entire contents of which are hereby incorporated by reference for all purposes as if fully set forth herein.

### BACKGROUND

### Field of the Disclosure

This disclosure relates to multifuel storage, fill, and delivery for fuel-agnostic (FA) engines, generators, and other related applications.

### Description of the Related Art

Traditional vehicles, engines, and power generation systems tend to operate on a single fuel or include separate systems in which either a first system (e.g., a fuel-based system) supplies power or a separate system (e.g., an electric (battery) system supplies power.

### SUMMARY

Embodiments of a multi-fuel system include a fuel-agnostic (FA) engine and/or generator that is able to produce mechanical and electrical power from the fuel energy content in a variety of fuels.

Multi-fuel storage, fill, and delivery solutions enable the use of a variety of fuels in the FA engine, generator, and/or other related applications. It is advantageous to utilize the described systems and methods in this regard.

In certain embodiments, multi-fuel systems may include different storage tanks that separate and manage the fuels independently for both fill and metering to the FA engine and/or generators. This may allow vehicles to operate on certain fuels, such as hydrogen, in certain areas, such as zero-emission vehicle (ZEV) zones or ultra-low emission zones, and operate the same engine using other fuels in areas outside of ZEV zones or ultra-low emission zones when zero or ultra-low emissions are not required.

In certain embodiments, multi-fuel systems may include a combination tank system designed to accommodate multiple fuels with different physical fill features and/or properties. This mixed fuel storage allows the operator to fill a tank with a variety of gaseous fuels depending on availability, price, preference, etc. Fuel tanks would be of the proper pressure rating and materials for pure and/or mixed gas usage.

Embodiments of a multi-fuel system allow maximum utilization of available or preferred fuel. Embodiments of a multi-fuel system allow each tank in a plurality of tanks to be filled with one or more fuels instead of individual tanks carrying a single, specific fuel (which limits the amount of specific fuel filling/dispensing). Embodiments of a multi-fuel system may also determine the volumetric energy content of the mixed gaseous fuel, which is as advantageous for travel distance calculation.

A contact switch, or flow switch, may indicate which fill port is being used. With a known volume of the fuel storage tanks (V=constant) and the known energy content of the incoming fuel, a fuel controller can utilize the Ideal Gas Law and Law of Partial Pressures to calculate the new energy content knowing the starting Pressure and Temperature (P1, T1) and the ending Pressure and Temperature (P2, T2). This allows a clear knowledge and indication of the stored energy content. Density, viscosity, and other gaseous properties may also be calculated. Along with knowing the energy content, and gas mixture properties, mixing for desired air/fuel ratio (i.e. Lamda) for proper and efficient combustion may be achieved.

Embodiments of a multi-fuel system may also be implemented to determine the volumetric energy content of the mixed gaseous fuel. A portion of a fuel gas mixture may be passed through a flow switch or other metering/measurement device, such as a Coriolis meter, which provides volumetric flow and density at a determined pressure and temperature. A metered amount of a fuel (including a mixed fuel) may be combusted with a proportioned/metered amount of air, resulting in a burning temperature that can be measured with a thermocouple. The burn temperature may be referenced from the temperature of inlet gasses (fuel and air) to determine a temperature rise. These readings of flows, density, and temperatures allow calculations for the determination of mixed fuel-gas energy content.

Fuel energy content information may be passed to energy conversion devices (i.e., engines and/or generators) so optimized burn, combustion, electrochemical conversion, etc. can be optimized.

Furthermore, knowledge of the pressure, temperature, volume, and energy content allows better accuracy for predicting travel distance. For example, a low-energy fuel may show a certain tank pressure, but this low-energy fuel may not be able to support vehicle travel distance that a higher-energy fuel would afford. Even higher accuracy distance estimation capability may be made when coupled with “look-ahead” travel path technology. This “look-ahead” also accounts for efficiency, road grade, speed, distance, and other attributes.

Multi-fuel systems may comprise at least one fuel tank, a first fuel receptacle configured to accept a first fuel, at least a second fuel receptacle configured to accept a second fuel, at least one sensor configured to detect fuel filling specific to each respective fuel receptacle, at least one sensor configured to detect a quantity of the first fuel or the second fuel, a fuel-agnostic engine configured to selectively burn one or more of the first fuel and the second fuel and a fuel controller. The fuel controller comprises a processor that executes instructions to determine an energy content of the first fuel in the at least one fuel tank, determine an energy content of the second fuel in the at least one fuel tank, determine a mass property of the first fuel in the at least one fuel tank from the sensed fuel fill, determine a mass property of the second fuel in the at least one fuel tank from the sensed fuel fill and determine fuel proportions of the first fuel and the second fuel in the at least one fuel tank based on the energy content and the mass property of the first fuel and the energy content and mass properties of the second fuel in the at least one fuel tank.

In some embodiments, a first tank of the at least one fuel tank stores a mixture of the first fuel and the second fuel, and a second fuel tank of the at least one fuel tank stores a single fuel. The processor executes the instructions to determine the fuel proportions of the first fuel and the second fuel in the first fuel tank based on the energy content and the mass property of the first fuel and the energy content and mass properties of the second fuel in the first fuel tank and determine a quantity of the single fuel in the second fuel tank.

In some embodiments, a multi-fuel system comprises a flow switch configured to measure the flow rate of the first fuel or the second fuel into the at least one tank, wherein the processor executes the instructions to determine one or more of the energy content and the mass property for the first fuel based on a measured flow rate of the first fuel through the flow switch.

In some embodiments, a multi-fuel system comprises a make switch coupled to the first fuel receptacle, wherein the make switch is configured to communicate a signal to the processor when an external fuel source is connected to the first fuel receptacle. The processor executes the instructions to determine the first fuel is being added and determine one or more of the energy content and the mass property for the first fuel based on a measured flow rate of the first fuel through the flow switch.

A method for fueling a vehicle may comprise a fuel controller getting values for a set of tank parameters for each tank corresponding to the fuel type, determining a composition (including characteristics) of the fuel in the tank, and preparing for receiving fuel, which may include opening or closing one or more check valves and shut-off valves, performing a set of pre-fill checks, communicating with a check valve corresponding to the fuel to open to receive the fuel, updating fuel characteristics including gas energy content and properties and updating fuel composition.

In some embodiments, the fuel controller also communicates with a set of sensors to monitor for any fuel fill safety faults, communicates with a fuel pressure sensor to determine if the present fuel pressure is below a maximum fuel pressure, determines if a command is received indicating the fuel filling process should end. If any fuel fill safety faults are detected, the fuel controller sends a report indicating any faults.

A method for fueling a vehicle may comprise a fuel controller getting fuel characteristics of the fuel in each tank of a plurality of tanks, determining target values for operating parameters of a vehicle over a route, determining predicted values for operating parameters of an engine over the route using a first fuel and comparing the predicted values with the target values to determine if the vehicle can meet a set of operating requirements using only the first fuel over the route. If the fuel controller determines the vehicle cannot use only one fuel to meet all the operating requirements for travel over a route, the fuel controller may identify one or more segments of the route for using a second fuel to supply to the engine. If the fuel controller determines the vehicle operating with the engine supplied with first fuel and/or second fuel on each segment cannot meet all the requirements, the fuel controller may determine the vehicle needs to add one or more of the first fuel and the second fuel. The fuel controller communicates with fuel pressure sensors, fuel temperature sensors, forward pressure regulators, and flow control valves to supply one of the two (or more) fuels to the engine according to a performance plan.

Some embodiments may be communicatively coupled over a network to a route planning server configured to get route data and devise/calculate a performance plan. A performance plan comprises target values for a set of operating parameters for the engine, the M/G, the battery system, and the multi-fuel system to minimize the operating cost of the vehicle over the route, minimize the environmental impact of the vehicle over the route, maximize power or extend a service life for the vehicle. A performance plan may be sent before the start of a route and updated performance plans may be sent in real-time to adjust for weather, traffic, a change in the route, or the vehicle performance being less than expected.

### BRIEF DESCRIPTION OF THE DRAWINGS

For a more complete understanding of the present invention and its features and advantages, reference is now made to the following description, taken in conjunction with the accompanying drawings, in which:

FIG. 1 depicts a diagram of a multi-fuel system for storing two or more fuels and for supplying one or more fuels to a multi-fuel capable engine;

FIG. 2 depicts a diagram of a multi-fuel system for storing two or more fuels and supplying one or more fuels to a multi-fuel capable engine;

FIG. 3 depicts a diagram of a multi-fuel system for storing two or more fuels and for supplying one or more fuels to a multi-fuel capable engine;

FIG. 4 depicts a flow diagram illustrating a method for a multi-fuel system supplying one of a first fuel or a second fuel to a multi-fuel capable engine;

FIG. 5 depicts a flow diagram illustrating a method for a multi-fuel system determining which of a first fuel or a second fuel or both fuels to supply to a multi-fuel capable engine;

FIG. 6 depicts a flow diagram of a method for generating a performance plan for a multi-fuel system;

FIG. 7 depicts a data structure containing values for tank parameters for a vehicle having a multi-fuel system; and

FIG. 8 depicts a data structure containing a set of characteristics of fuels in a vehicle having a multi-fuel system.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

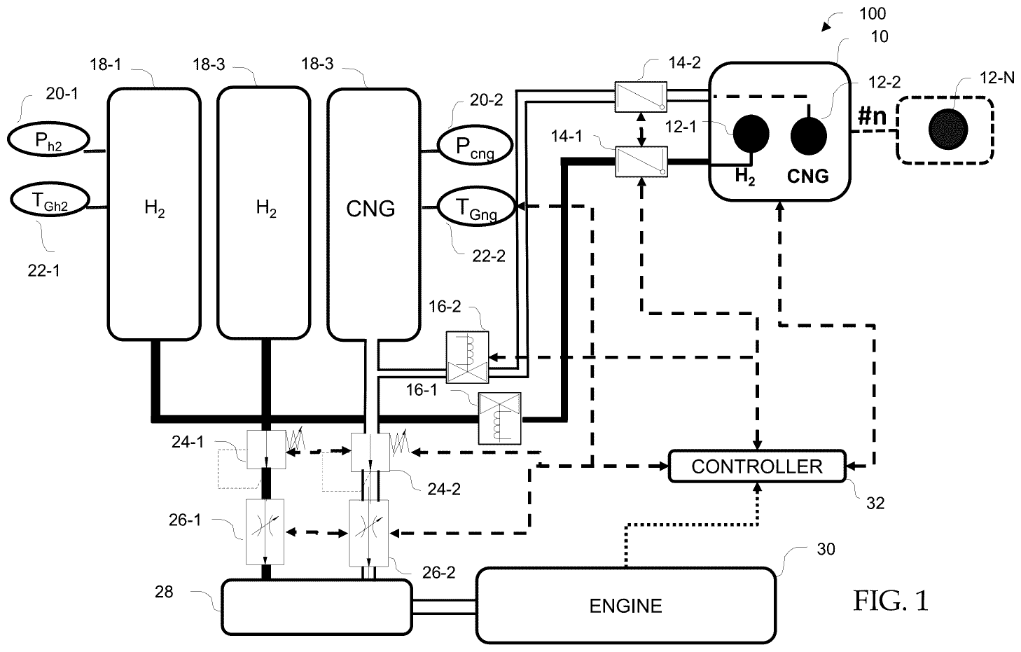

Particular embodiments may be best understood by reference to FIGS. 1-8, wherein like numbers are used to indicate like and corresponding parts.

### System Overview

Embodiments may form part of a vehicle, such as a hybrid electric truck or a hybrid electric truck-trailer combination, or fully electric truck, or a fully electric truck/trailer combination as disclosed herein. Referring to FIGS. 1-3, embodiments of a multi-fuel system 100 may be configured to receive and store one or more fuels in a plurality of tanks and supply the one or more fuels to a fuel-agnostic (FA) engine and/or generator capable of selectively operating on various fuel types.

### Multi-Fuel Systems

FIG. 1 depicts a diagram of one embodiment of a multi-fuel system 100 for storing one or more fuels and for selectively supplying the one or more fuels for use in a vehicle 40.

As depicted in FIG. 1, multi-fuel system 100 comprises fuel fill manifold 10 comprising a plurality of fuel receptacles 12-1 to 12-N, wherein each fuel receptacle 12 may be configured to receive a particular type of fuel or may be configured to receive any of a plurality of fuel types (e.g., fuel receptacle 12-1 may be configured to receive hydrogen and fuel receptacle 12-2 may be configured to receive compressed natural gas (CNG)). Multi-fuel system 100 further comprises valves (which may include check valves 14 and/or shut-off valve 16) between each fuel receptacle 12 or the fuel fill manifold 10 and one or more tanks 18 of a plurality of tanks 18. As depicted in FIG. 1, shut-off valves 16 may be a solenoid valve. Fuel is stored in the plurality of tanks 18, wherein each tank 18 may be configured for storing a variety of different fuels or a single fuel. Each tank 18 may have a set of sensors including fuel pressure sensor 20 and fuel temperature sensor 22.

A fuel control system controls the flow of fuel stored in tanks 18 through forward pressure regulators 24 and flow control valve 26 to an optional mixing manifold 226 for supplying fuel to engine 30. In some embodiments, engine 30 may be an internal combustion engine including a generator or a fuel-agnostic generator, capable of operating on various fuel types including liquid and gaseous fuels. Fuel controller 32 may communicate with check valves 14, the shut-off valve 16, fuel pressure sensors 20, fuel temperature sensors 22, forward pressure regulators 24, the flow control valve 26, and engine 30 to determine what fuels are in tanks 18 and how much fuel is in each tank 18, and supply engine 30 with a fuel from one or more tanks 18 based on a performance plan (discussed in more detail below). As depicted in FIG. 1, multi-fuel system 100 may be configured with a single temperature sensor 20-1 and pressure sensor 22-1 for monitoring temperature and pressure in tanks 18-1 and 18-2 storing the same fuel. In other embodiments, each tank 18 may comprise a corresponding temperature sensor 20 and pressure sensor 22.

Embodiments of multi-fuel system 100 may store and supply multiple different types of fuels in tanks 18. For example, fuel receptacle 12-1, check valve 14-1, the shut-off valve 16-1, tanks 18-1 and 18-2, fuel pressure sensor 20-1, fuel temperature sensor 22-1, forward pressure regulator 24-1 and flow control valve 26-1 may be configured to receive, store and supply a first fuel (e.g., hydrogen) and fuel receptacle 12-2, check valve 14-2, the shut-off valve 16-2, fuel tank 18-2 fuel pressure sensor 20-2, fuel temperature sensor 22-2, forward pressure regulator 24-2 and flow control valve 26-2 may be configured to receive, store and supply a second fuel (e.g., compressed natural gas CNG). However, it will be appreciated that any mix of tank/fuel combinations may be used in a multi-fuel system 100.

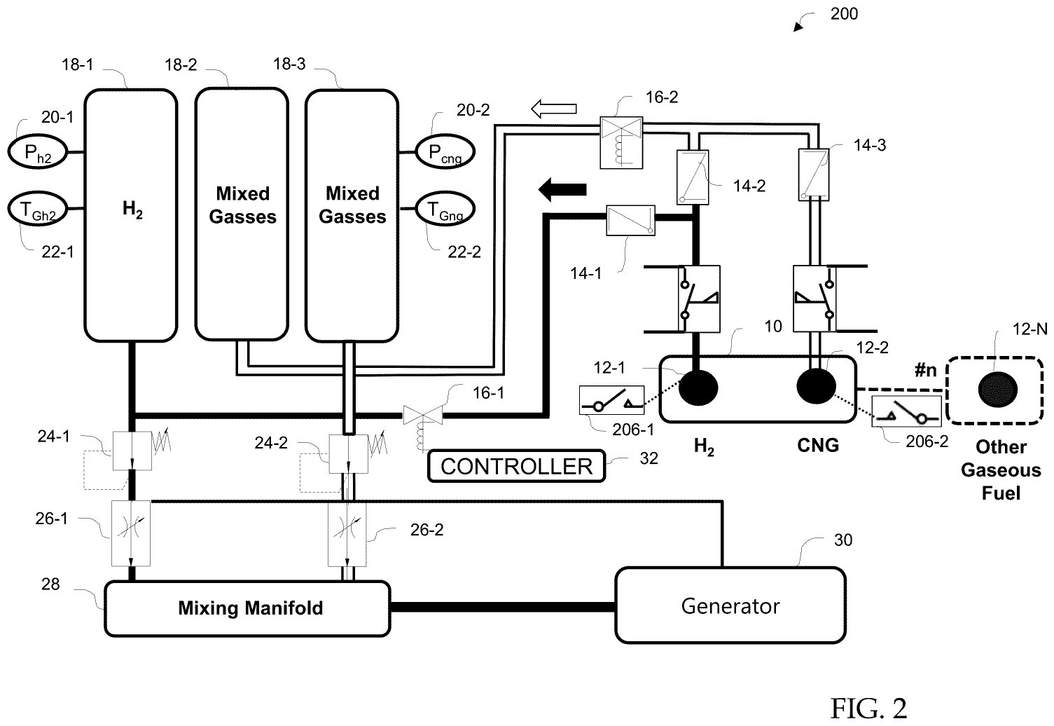

FIG. 2 depicts a diagram of an embodiment of a multi-fuel system 200 for storing two or more fuels and for supplying one or more fuels for use in a vehicle 40.

Referring to FIG. 2, multi-fuel system 200 comprises fuel fill manifold 10 comprising a plurality of fuel receptacles 12-1 to 12-N, wherein each fuel receptacle 12 may be configured to receive a particular type of fuel or configured to receive any of a plurality of fuel types.

Multi-fuel system 200 further comprises valves (which may include check valves 14 and/or shut-off valves 16) between each fuel receptacle 12 or fuel fill manifold 10 and a tank 18 of a plurality of tanks 18. As depicted in FIG. 2, check valve 14-1 may be opened, and check valve 14-2 may be closed to route a first fuel (e.g., hydrogen) to flow into tank 18-1 configured to store only the first fuel as a single fuel and check valve 14-2 may be opened and check valves 14-1 and 14-3 may be closed to route the first fuel into tanks 18-2 and 18-3 configured to store two or more fuels as a mixed fuel. Check valve 14-3 may be opened and check valve 14-2 may be closed to route a second fuel (e.g., CNG) into tanks 18-2 and 18-3.

In some embodiments, multi-fuel system 200 comprises switches 206. Switches 206 can indicate to fuel controller 32 (discussed below) which fuel receptacle 12 is being used with an associated fuel. Each switch 206 may be a make switch configured to when an external fuel source is connected to a corresponding fuel receptacle 12 (e.g., the first switch 206-1 may be a make switch configured to indicate when an external fuel source is connected to fuel receptacle 12-1, the second switch 206-2 may be a make switch configured to indicate when an external fuel source is connected to fuel receptacle 12-2, etc.).

In some embodiments, multi-fuel system 200 comprises one or more flow switches 208. In some embodiments, flow switches 208 may be configured to allow fueling at a certain rate or may measure the flow rate of a fuel during a fuel fill. In some embodiments, flow switches 208 comprise flow meters for determining how much fuel is added to one or more tanks 18.

Fuel is stored in one or more tanks 18 of a plurality of tanks 18, wherein each tank 18 may be configured for storing a variety of different fuels or a single fuel. Each tank 18 may have a set of sensors including fuel pressure sensor 20 and fuel temperature sensor 22.

Fuel stored in tanks 18 may be supplied independently (as a single fuel, for example, in tank 18-2) or combined (as a mixed fuel, for example in tank 18-2 and/or tank 18-3) to engine 30. Fuel stored in tanks 18 may flow through forward pressure regulators 24 and flow control valves 26 to engine 30. In some embodiments, engine 30 may be an internal combustion engine, a generator, or a fuel-agnostic generator capable of operating on various fuel types.

Fuel controller 32 may control whether a single fuel or a mixture of two or more fuels is supplied to engine 30. To do this, fuel controller 32 may know what fuels are in each tank 18.

During fueling, fuel controller 32 may communicate with pressure sensors 20 and temperature sensors 22 to determine a starting pressure (P1) and starting temperature (T1) for each tank 18. Fuel controller 32 may communicate with one or more of fuel switches 206 to determine when fueling begins, including what fuel is being added. Fuel controller 32 may communicate with flow switches 208 to determine a flow rate of the fuel being added. Fuel controller 32 may communicate with one or more check valves 14 and/or shut-off valves 16 to determine what tanks 18 the fuel is being routed for storage. As the fuel is being added, fuel controller 32 may communicate with pressure sensors 20 and temperature sensors 22 to determine an ending pressure (P2) and ending temperature (T2) for each tank 18.

With a known volume (V=constant) of each tank 18 along with the starting pressure (P1), the starting temperature (T1), the ending pressure (P2) and the ending temperature (T2) and the known energy content of the incoming fuel, fuel controller 32 can utilize the Ideal Gas Law and Law of Partial Pressures to calculate the energy content of fuel added to one or more tanks 18. The calculated energy content of the added fuel can be added to a stored value for the energy content of fuels already stored in tanks 18 to determine the total energy content of fuels stored in tanks 18. Fuel controller 32 may also calculate density, viscosity, and other gaseous properties through this process. With a known energy content and gas mixture properties, fuel controller 32 can communicate with fuel pressure regulators 24 and flow control valves 26 to route a single fuel or mix fuels for a desired air/fuel ratio (e.g., Lambda) for engine 30. In some embodiments, fuel controller 32 can communicate with fuel pressure regulators 24 and flow control valves 26 to route one or more fuels to the mixing manifold 28 for supplying a mixed fuel to engine 30.

In some embodiments, engine 30 may be an internal combustion engine, a generator, or a fuel-agnostic generator, capable of operating on various fuel types.

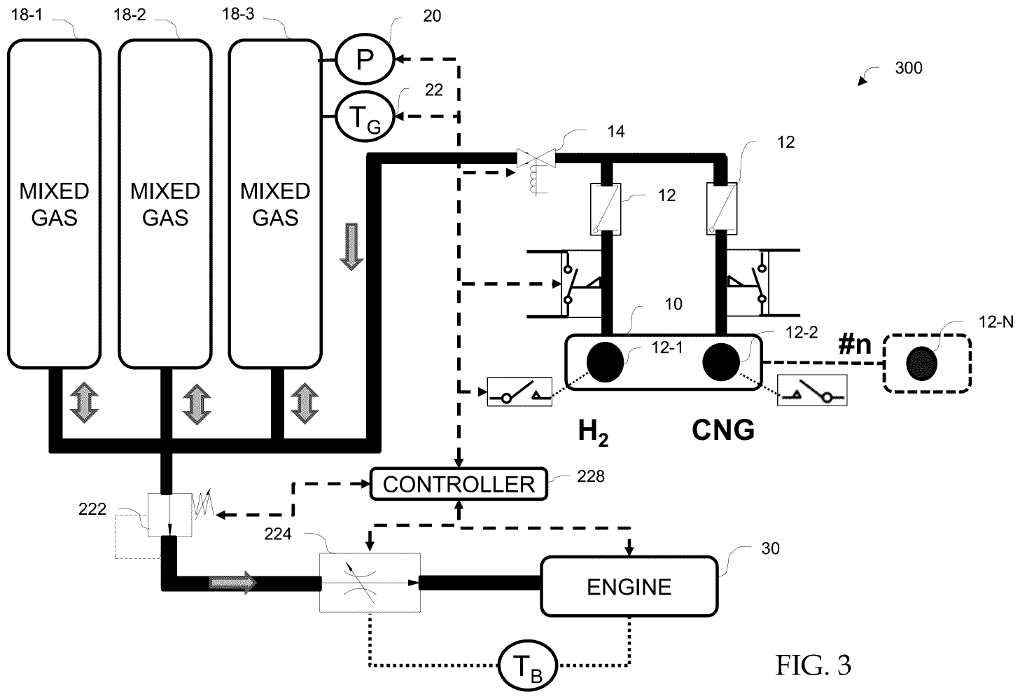

FIG. 3 depicts a diagram of an embodiment of a multi-fuel system 300 for storing two or more fuels and for supplying one or more fuels for use in a vehicle 40.

As depicted in FIG. 3, multi-fuel system 300 comprises fuel fill manifold 10 comprising a plurality of fuel receptacles 12-1 to 12-N, wherein each fuel receptacle 12 may be configured to receive a particular type of fuel or configured to receive any of a plurality of fuel types.

Multi-fuel system 300 further comprises valves (which may include check valves 14 and/or shut-off valve 16) between each fuel receptacle 12 or fuel fill manifold 10 and a plurality of tanks 18.

If a first fuel (e.g., hydrogen) is to be added to tanks 18, check valve 14-1 and shut-off valve 16 may be opened, and check valve 14-2 may be closed to route the first fuel to tanks 18 storing two or more fuels as a mixed fuel. If a second fuel (e.g., CNG) is to be added to tanks 18, check valve 14-2 and shutoff valve 16 may be opened and check valve 14-1 may be closed to route the second fuel to flow into tanks 18. In some embodiments, shut-off valves 16 may be solenoid valves.

In some embodiments, multi-fuel system 300 comprises switches 206. Switches 206 can indicate to fuel controller 32 (discussed below) which fuel receptacle 12 is being used with an associated gas. Each switch 206 may be a make switch configured to when an external fuel source is connected to a corresponding fuel receptacle 12 (e.g., the first switch 206-1 may be a make switch configured to indicate when an external fuel source is connected to fuel receptacle 12-1, the second switch 206-2 may be a make switch configured to indicate when an external fuel source is connected to fuel receptacle 12-2, etc.).

In some embodiments, multi-fuel system 300 comprises one or more flow switches 208. Flow switches 208 may be configured to allow fueling at a certain rate or may measure the flow rate of a fuel. In some embodiments, flow switches 208 comprise flow meters for determining the rate at which fuel is being added to tanks 18.

Fuel is stored in one or more tanks 18 of a plurality of tanks 18, wherein each tank 18 may be configured for storing a variety of different fuels as a single fuel or as a mixed fuel of two or more fuels. Each tank 18 may have a set of sensors including fuel pressure sensor 20 and fuel temperature sensor 22.

Fuel stored in tanks 18 may flow through forward pressure regulators 24 and flow control valves 26 to engine 30. In some embodiments, engine 30 may be an internal combustion engine, a generator, or a fuel-agnostic generator capable of operating on various fuel types.

Fuel controller 32 may control whether a single fuel or a mixture of two or more fuels is supplied to engine 30. Fuel controller 32 may communicate with pressure sensors 20 and temperature sensors 22 to determine a starting pressure (P1) and starting temperature (T1) for each tank 18. Fuel controller 32 may communicate with one or more fuel switches 206 to determine when fueling begins, including what fuel is being added. Fuel controller 32 may communicate with one or more flow switches 208 to determine the flow rate of the fuel being added. Fuel controller 32 may communicate with one or more of valves 14, 16 to determine what tanks 18 the fuel is being routed for storage. As the fuel is being added, fuel controller 32 may communicate with pressure sensors 20 and temperature sensors 22 to determine an ending pressure (P2) and ending temperature (T2) for each tank. With a known volume (V=constant) of tanks 18, the starting pressure (P1), the starting temperature (T1), the ending pressure (P2) and the ending temperature (T2), and the known energy content of the incoming fuel, fuel controller 32 can utilize the Ideal Gas Law and Law of Partial Pressures to calculate the energy content of added fuel inside tanks 18. The calculated energy content of the added fuel can be added to a stored value for the energy content of fuels already stored in tanks 18 to determine the total energy content of fuels stored in tanks 18. Fuel controller 32 may also calculate density, viscosity, and other gaseous properties through this process. With a known energy content and gas mixture properties, fuel controller 32 can communicate with fuel pressure regulators 24 and flow control valves 26 to route a single fuel or mix fuels for a desired air/fuel ratio (e.g., Lambda) for engine 30. In some embodiments, fuel controller 32 may communicate with fuel pressure regulators 24 and flow control valves 26 to route one or more fuels to mixing manifold 226 for supplying a mixed fuel to engine 30.

In some embodiments, engine 30 may be an internal combustion engine, a generator, or a fuel-agnostic generator, capable of operating on various fuel types.

### Each Fuel Tank can Store a Single Fuel or a Fuel Mixture

FIG. 1 depicts a multi-fuel system with a single tank 18 for each fuel. FIG. 2 depicts a multi-fuel system 200 with a first set of tanks (e.g., tank 18-1) for storing a single fuel and a second set of tanks (e.g., 18-2 and 18-3) for storing multiple fuels as a mixed fuel. FIG. 3 depicts a multi-fuel system 300 with multiple tanks for storing a mixture of fuels as a mixed fuel. Fuels may include, for example, hydrogen, diesel, gasoline, propane, biodiesel, ethanol (E85), and compressed natural gas (CNG).

### Fuel Selection is Based on Operating Requirements and Fuel Properties

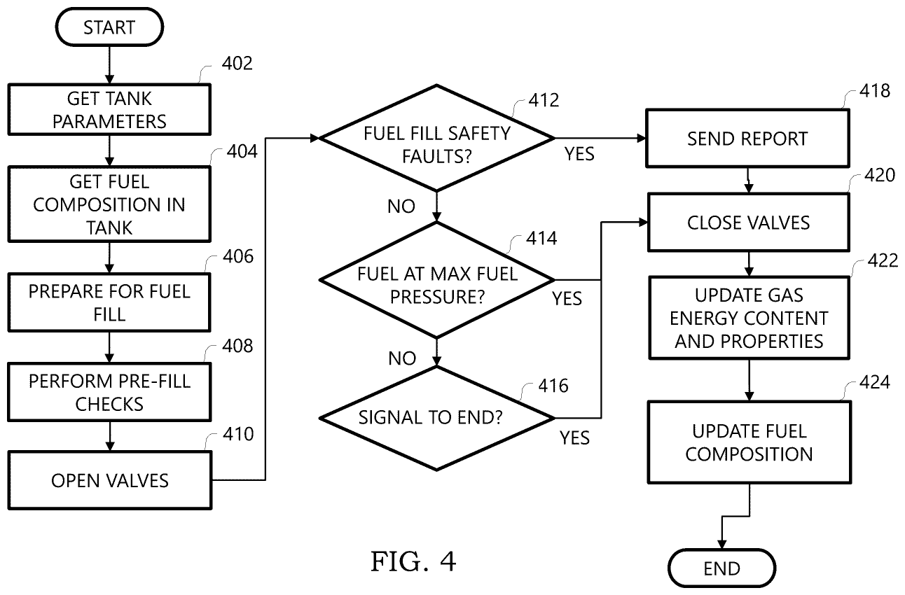

FIG. 4 depicts a flow diagram of a method for multi-fuel systems 100, 200, and 300 to determine a fuel or set of fuels based on a set of operating requirements for vehicle 40 for a route and the characteristics of each fuel stored in tanks 18.

At step 402, fuel controller 32 gets values for a set of tank parameters for each tank 18 corresponding to the fuel type. Values for the set of tank parameters may include constants, such as the tank volume and a maximum fuel pressure, and may include variables, such as a maximum fuel pressure based on an ambient temperature or a fuel temperature. Fuel controller 32 may communicate with fuel pressure sensor 20 to determine a starting fuel pressure (P1) and communicate with fuel temperature sensor 22 to determine a starting fuel temperature (T1).

At step 404, fuel controller 32 determines a composition (including characteristics) of the fuel in the tank 18. In some scenarios, a tank 18 may contain a single fuel (e.g., hydrogen) with a defined composition and properties. In other scenarios, a tank 18 may contain a fuel mixture, wherein fuel controller 32 may calculate a fuel composition or may refer to data structures stored in memory to determine the composition of the fuel mixture. Fuel controller 32 may determine the fuel composition by communicating with memory storing values for the fuel composition or may calculate the fuel composition. Characteristics may include, for example, a maximum fuel pressure, a minimum fuel pressure, and a maximum rate at which the fuel may flow into tank 18, for example.

At step 406, fuel controller 32 prepares for receiving fuel, which may include opening or closing one or more check valves 14 and shut-off valves 16. Fuel controller 32 may communicate with switches 206 to determine if an external fuel source is connected to a fuel receptacle 12 and communicate with flow switches 208 to begin measuring the rate at which fuel flows to tanks 18, for example. Fuel controller 32 may communicate with other components of the drivetrain on vehicle 40 to prepare for receiving fuel. For example, fuel controller 32 may communicate with a battery system to ensure the battery system supplies electric power to components of multi-fuel system 100, 200 or 300 during the fuel filling process.

At step 408, fuel controller 32 performs a set of pre-fill checks. Pre-fill checks may include determining an ambient air temperature and calculating a temperature-based maximum fuel pressure based on the ambient air temperature. In some embodiments, pre-fill checks may include communicating with tank pressure sensor 20 and tank temperature sensor 22 to determine a starting fuel pressure (P1) and a starting fuel temperature (T1) and calculating a temperature-based maximum fuel pressure based on the fuel temperature.

At step 410, fuel controller 32 communicates with a check valve 14 corresponding to the fuel to open to receive the fuel. In some embodiments, fuel controller 32 communicates with a shut-off valve 16 corresponding to the fuel to open to receive the fuel.

At step 412, fuel controller 32 communicates with a set of sensors to monitor for any fuel fill safety faults. For example, fuel controller 32 may communicate with fuel pressure sensor 20 to ensure the fuel pressure is above a minimum fuel pressure needed to receive the fuel.

At step 414, fuel controller 32 communicates with fuel pressure sensor 20 to determine if the present fuel pressure is below a maximum fuel pressure. A maximum fuel pressure may be the absolute maximum fuel pressure or the temperature-based maximum fuel pressure that tank 18 can hold.

At step 416, fuel controller 32 determines if a command is received indicating the fuel filling process should end. An operator might not want to fill tank 18 to a maximum fuel pressure each time fuel is added. In some embodiments, fuel controller 32 receives a signal (or stops receiving a signal) from switches 206, indicating an external source of fuel is going to be disconnected from fuel receptacle 204.

At step 418, if any fuel fill safety faults are detected, fuel controller 32 sends a report indicating any faults detected during the filling process.

At step 420, fuel controller 32 communicates with check valve 14 and shut-off valve 16 to close. For example, if any sensors detect fuel fill safety faults (e.g., fuel pressure sensor 20 indicates fuel in tank 18 is at a maximum fuel pressure, or fuel controller 32 receives a signal indicating the fuel filling process should end, fuel controller 32 communicates with check valve 14 and shut-off valve 16 to close. Fuel controller 32 may communicate with flow switches 208 to stop measuring flow rate.

At step 422, fuel controller 32 updates fuel characteristics including gas energy content and properties. Updating fuel characteristics may include determining an ending pressure (P2) and an ending temperature (T2) in one or more tanks 18 and utilizing the Ideal Gas Law and Law of Partial Pressures to calculate the energy content of added fuel inside tanks 18.

At step 424, fuel controller 32 updates fuel composition. If tank 18 contains a single fuel, fuel controller 32 may simply add the amount of added fuel to the previous amount of fuel. If tank 18 contains a mixture of two fuels, fuel controller 32 may calculate the fuel composition, including determining any changes in properties. Updating fuel composition may include updating a cost of fuel in tank 18.

### Supplying Fuel to Meet the Operating Requirements of the Vehicle

When vehicle 40 is operating with engine 30 generating power, embodiments of the multi-fuel system 100, 200, or 300 may supply fuel from one or more tanks 18 to engine 30.

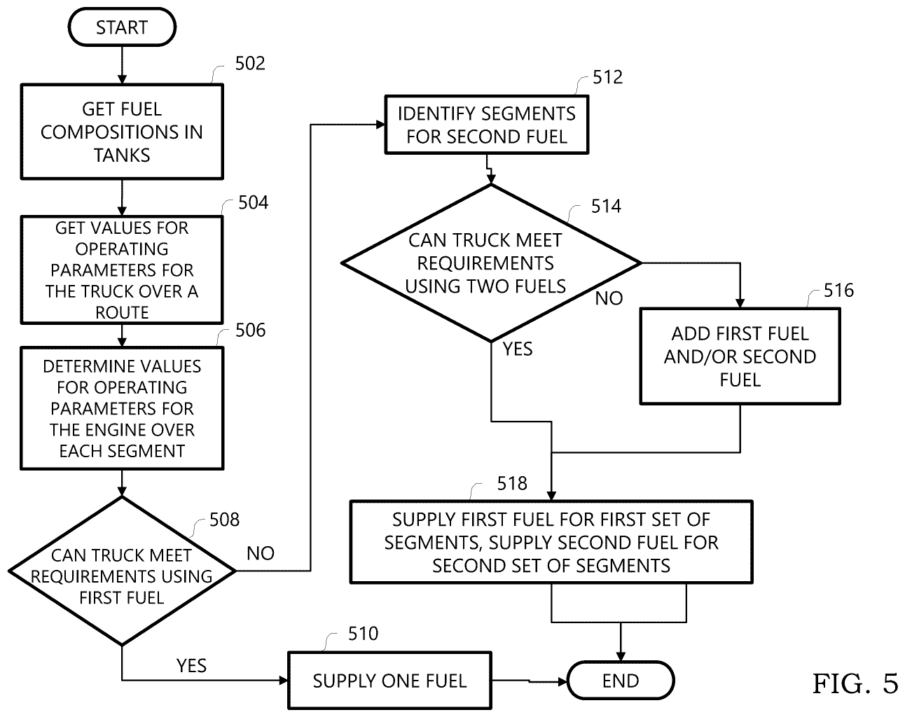

FIG. 5 depicts a flow diagram of a method for supplying fuel to engine 30 using multi-fuel system 100, 200, or 300.

At step 502, fuel controller 32 gets fuel characteristics of the fuel in each tank 18 of a plurality of tanks 18.

At step 504, fuel controller 32 determines target values for the operating parameters of vehicle 40 over a route. In some embodiments, fuel controller 32 determines target values for operating parameters of vehicle 40 based on a performance plan, discussed in more detail below.

At step 506, fuel controller 32 determines predicted values for operating parameters of engine 30 over the route using a first fuel. In some embodiments, fuel controller 32 determines predicted values for operating parameters of engine 30 based on a performance plan, discussed in more detail below.

At step 508, fuel controller 32 compares the predicted values with the target values to determine if vehicle 40 can meet a set of operating requirements using only the first fuel over the route. For example, an operating requirement may be that a fuel cost for engine 30 is below a threshold amount or a threshold rate. As another example, an operating requirement may be that vehicle 40 emits zero emissions over a segment of the route. Other examples include vehicle 40 is able to travel a minimum distance, that a battery system in vehicle 40 has a minimum state of charge (SOC) at an end of a segment or an end of the route, and/or that an amount of a first fuel and/or a second fuel is above a minimum fuel amount.

At step 510, if fuel controller 32 determines that vehicle 40 can travel over the route using only one fuel and meet all the operating requirements for the vehicle 40, fuel controller 32 may communicate with fuel pressure sensor 20, fuel temperature sensor 22, forward pressure regulator 24 and flow control valve 26 to supply only one fuel to engine 30 over all the segments of the route. Fuel controller 32 communicates with engine 30 to monitor values for operating parameters of engine 30 including operating efficiency and engine output power. Sensors on engine 30 may monitor performance of engine 30 and communicate signals to fuel controller 32 to adjust the fuel flow rate or fuel pressure to adjust the performance of engine 30 to meet the operating requirements of vehicle 40.

At step 512, if fuel controller 32 determines vehicle 40 cannot use only one fuel to meet all the operating requirements for travel over a route, fuel controller 32 may identify one or more segments of the route for using a second fuel to supply to engine 30.

At step 514, fuel controller 32 determines if vehicle 40 operating with engine 30 supplied with either the first fuel or the second fuel on each segment of the route can meet all the operating requirements for the route.

At step 516, if fuel controller 32 determines vehicle 40 operating with engine 30 supplied with first fuel and/or second fuel on each segment cannot meet all the requirements, fuel controller 32 may determine vehicle 40 needs to add one or more of the first fuel and the second fuel. Fuel controller 32 may determine when and where to add fuel, including what type of fuel and how much.

At step 518, fuel controller 32 communicates with fuel pressure sensors 20, fuel temperature sensors 22, forward pressure regulators 24 and flow control valves 26 to supply one of the two (or more) fuels to engine 30. Fuel controller 32 may communicate with engine 30 to determine values for the operating parameters of engine 30 including operating efficiency and engine output power and adjust the first fuel flow rate or first fuel pressure for a first set of segments and adjust the second fuel flow rate or the second fuel pressure for a second set of segments.

### Fuel Controller Uses a Performance Plan to Manage the Fuel Supply

Fuel controller 32 on vehicle 40 may communicate with engine 30 and other systems on vehicle 40 to collect present drivetrain configuration information including values for operating parameters and determine a performance plan with a set of drivetrain configuration instructions including target values for one or more operating parameters of the vehicle 40 for a route. In some embodiments, fuel controller 32 may communicate over a network with a server (not shown) configured to determine and send a performance plan to vehicle 40.

A performance plan may include a drivetrain configuration instruction to operate engine 30 to not operate engine 30, to operate a M/G as a motor, to operate the M/G as a generator, to supply electric power from the battery system to the M/G operating as a motor, and to supply a fuel or a mixture of two fuels to engine 230.

A performance plan may include values for a set of operating parameters of the vehicle 40 including values for operating the engine 30 below a maximum engine operating speed value or within a range of engine operating speed values, for operating the M/G as a motor below a maximum motor operating speed value or within a range of motor operating speed values, for operating the M/G as a generator below a maximum generator operating speed value or within a range of generator operating speed values

A performance plan may be communicated to vehicle 40 before vehicle 40 starts traveling on a route. A subsequent performance plan may be communicated to vehicle 40 as the vehicle 40 travels on the route. For example, traffic, an accident, or a road closure may cause a delay that may affect fuel levels dropping below a minimum amount, or vehicle performance may be less than predicted due to weather or road conditions. In some embodiments, a performance plan may be communicated periodically to vehicle 40.

A performance plan communicated to a vehicle 40 may provide general operating parameters but still allow a driver to drive the vehicle based on actual road conditions, traffic, visibility, weather, and other safety concerns. For example, a route speed limit may be 65 miles per hour, and a vehicle 40 may be traveling over the route at 45 miles per hour because the driver has determined it is not safe to travel at 65 miles per hour (there may be bad weather, poor visibility, an accident, road maintenance, etc.). Embodiments may determine a drivetrain configuration of the vehicle 40 based on the current vehicle speed of 45 miles per hour and generate a performance plan with a set of operating parameters for the vehicle 40, but do not send any instructions to accelerate the vehicle 40. A performance plan may be updated in real-time to accommodate changes in traffic, weather, and a route, for example.

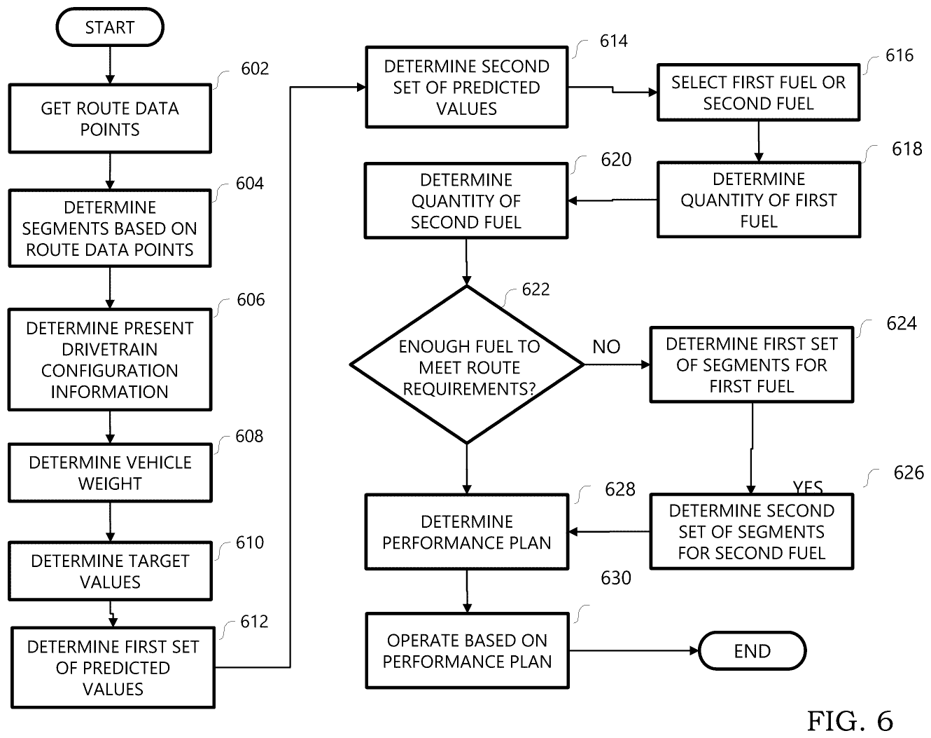

FIG. 6 depicts a flow diagram illustrating a method for generating a performance plan for a vehicle 40 having a multi-fuel system 100, 200, or 300.

A performance plan may be based on, for example, a distance of a segment or a total distance of a route, route terrain, proximity or location of various types of fueling stations along the route, identified green zones or areas in which regulations require vehicle 40 to operate based on values for one or more specific operating parameters, or a feedback loop based on values for an operating parameter such as temperature. A performance plan may include fuel selection of a single fuel or a mixture of two or more fuels for a portion of a route or an entire route and values for operating engine 30 using the single fuel or the mixture of two or more fuels. A mixture of two or more fuels may include a proportion of the two or more fuels.

At step 602, a server communicatively connected to fuel controller 32 gets route data points for a route over which vehicle 40 is expected to travel. Route data points may be retrieved from an outside source (such as by the server communicating with a global positioning satellite (GPS) source server) and may contain a large plurality of route data points. In some embodiments, route data points for a route over which vehicle 40 is expected to travel may be collected from one or more vehicles 40 that previously traveled over the route. In some embodiments, route data points may be stored in a data structure in the server.

At step 604, the server generates or compresses route data points into linearized segments. Compressing route data points into linearized segments comprises analyzing the route data points to determine sets of route data points that indicate uphill segments, downhill segments, and flat segments and determining a grade and distance for each segment. Determining a linearized segment may further include determining an elevation, a road surface, and other information about the segment. In some embodiments, determining a linearized segment may include determining the segment forms at least part of a zone associated with reduced emissions. Information about each linearized segment may be stored in a data structure on the server.

At step 606, the server determines the present drivetrain configuration information for vehicle 40. As used herein, present drivetrain configuration information refers to what components are installed on vehicle 40 and how they are operating. For example, drivetrain configuration may include information that a drivetrain includes engine 30, a motor/generator, and a battery system. Drivetrain information may also include information such as engine 30 has a particular displacement (e.g., 8.2 L), capable of providing a particular output power (e.g., 400 kW), and uses a particular type of fuel (e.g. diesel) or types of fuel (e.g., CNG, hydrogen), the motor/generator (M/G) is operable as a motor to provide rotational power (e.g., 400 kW) and operable as a generator to generate electric power (e.g., 350 kW) and the battery system has a maximum charge capacity (e.g., 500 Amp-hr), a maximum charge rate, a minimum charge capacity, a maximum discharge rate, a maximum operating temperature. Drivetrain configuration information may also include real-time information that engine 30 is operating at 85% efficiency to generate 400 kW of power, for example.

At step 608, the server may determine vehicle weight. Vehicle weight includes the weight of vehicle 40 plus any trailer coupled to vehicle 40 and any cargo in vehicle 40 or the trailer. In some embodiments, the server gets vehicle weight information stored in memory in vehicle 40.

### Single Fuel Supply Over a Route

At step 610, fuel controller 32 or a server communicatively connected to fuel controller 32 determines target values for operating parameters for each segment. Target values for operating parameters indicate how the drivetrain should operate to drive the vehicle over the segments in a route. In some embodiments, a target value for an operating parameter may be based on the vehicle 40 emitting zero emissions or low emissions in a segment. For example, a target value for an engine operating at zero emissions may indicate operating engine 30 using a fuel that does not produce carbon emissions. Other target values may include an engine speed range (e.g., 1800-2400 RPM), a M/G power range (e.g. 55-60% peak power), a maximum battery discharge rate, a maximum battery temperature, etc.

At step 612, embodiments determine a first set of predicted values for a set of operating parameters of the vehicle 40 corresponding to supplying a single first fuel to engine 30. The set of operating parameters may comprise an emissions output, an engine efficiency, an engine output power, a motor efficiency for the M/G operating as a motor, a generator efficiency for the M/G operating as a generator, and a battery state of charge (SOC).

At step 614, embodiments determine a second set of predicted values for the set of operating parameters of the vehicle 40 corresponding to supplying a second fuel to engine 30. The second fuel may correspond to a single fuel (as depicted in FIGS. 1 and 2). In some embodiments, the second fuel may correspond to one or more fuels stored as a mixed fuel (as depicted in FIGS. 2 and 3).

At step 616, embodiments compare the first set of predicted values to the second set of predicted values to determine whether to supply the first fuel or the second fuel to the engine based on the operating requirement.

### Fuel Switching

At step 618, embodiments determine a first fuel present quantity of the first fuel.

At step 620, embodiments determine a second fuel present quantity of the second fuel.

At step 622, embodiments may determine there is not enough of the first fuel or the second fuel to meet all the operating requirements for the route.

At step 624, embodiments determine, for the route, a first set of segments for which operating the engine supplied with the first fuel will meet a first operating requirement.

At step 626, embodiments determine, for the route, a second set of segments for which operating the engine supplied with the second fuel will meet a second operating requirement.

At step 628, fuel controller 32 determines a performance plan, or a server communicatively connected to fuel controller 32 sends a performance plan to the fuel controller 32. The performance plan includes a set of drivetrain configuration instructions and values for a set of operating parameters for vehicle 40 for at least one segment on the route the vehicle 40. The performance plan may include a set of drivetrain configuration instructions to supply a single fuel for all segments, include a set of drivetrain configuration instructions to supply two or more fuels as a mixed fuel for all segments, may include a first set of drivetrain configuration instructions to supply the first fuel to the engine 30 and operate the engine 30 in a first drivetrain configuration over each segment in the first set of segments and include a second set of drivetrain configuration instructions to supply the second fuel to the engine 30 and operate engine 30 in a second drivetrain configuration over each segment in the second set of segments, or may include a first set of drivetrain configuration instructions to supply the first fuel to the engine 30 and operate the engine 30 according to a set of operating parameters over each segment in the first set of segments and include a second set of drivetrain configuration instructions to supply two or more fuels as a mixed fuel to engine 30 and operate engine 30 in a second drivetrain configuration over each segment in the second set of segments.

At step 630, fuel controller 32 receives the performance plan and communicates with pressure regulators 24 and one or more flow control valves 26 to supply one or more fuels to engine 30 for each segment based on the performance plan. In some embodiments, flow controller 32 communicates with pressure regulators 26 and flow controllers 28 to control the flow of one or more fuels to engine 30 based on fuel energy content or mass properties. Controlling the flow of one or more fuels may include allowing only a single fuel to flow to engine 30. Controlling the flow of one or more fuels may include allowing only fuel from a single tank 18 or set of tanks 18 to flow to engine 30. If two or more fuels are to be supplied to engine 30, controlling the flow of one or more fuels may include controlling the proportions of two or more fuels.

In some embodiments, flow controller 32 communicates with pressure regulators 26 and flow controllers 28 to control the flow of one or more fuels to engine 30 based on temperature feedback received from engine 30.

### Tank Characteristics

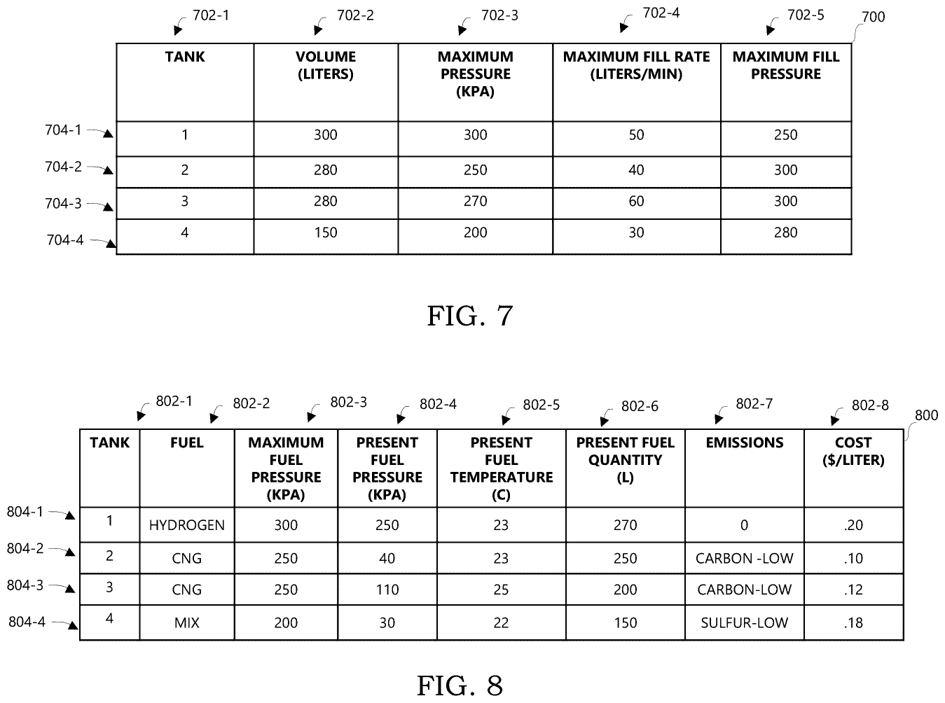

FIG. 7 depicts data structure 700 containing rows 704 corresponding to each tank 18 and columns 702 corresponding to characteristics of each tank 18. Tank column 702-1 may contain an identifier for a fuel tank 18. Volume column 702-2 may contain a value for the volume capacity of the tank 18. Maximum pressure column 702-3 may contain a value for the maximum pressure that tank 18 can hold. Maximum fill rate column 702-4 may contain a value for the maximum rate at which fuel may be added to tank 18. Maximum fill pressure column 702-5 may contain a value for the maximum pressure at which fuel may be added to tank 18.

### Fuel Characteristics

FIG. 8 depicts a data structure 800 comprising fuel characteristics of fuel stored in each tank 18. Tank column 802-1 contains an identifier for a fuel tank 18, fuel column 802-2 contains a value for the fuel type stored in the tank 18, maximum fuel pressure column 802-3 contains a value for the maximum fuel pressure of the fuel in the tank 18, present fuel pressure column 802-4 contains a value for the present fuel pressure of the fuel in the tank 18, present fuel temperature column 802-5 contains a value for the present fuel temperature of the fuel in the tank 18, present fuel quantity column 802-6 contains a value for the present quantity of the fuel in the tank 18, emissions column 802-7 contains a value for emissions generated when operating the engine with the fuel in the tank 18, and cost column 802-8 contains a value for the cost of the fuel in the tank 18. Data structure 800 may contain other columns for information as well. For example, data structure 800 may store a value for each fuel corresponding with how much power an engine can generate when supplied with the fuel in the tank 18 and the efficiency associated with the engine being supplied the fuel. Data structure 800 contains a row 804 for each tank 18. For example, data structure 800 contains four rows 804-1 to 804-4 corresponding to vehicle 40 having four fuel tanks 18.

Values for the maximum fuel pressure column 802-3, emissions column 802-7 and cost 802-8 depend on the characteristics of the fuel in the tank 18. For example, hydrogen has a higher maximum fuel pressure than CNG and has zero emissions but may cost more per unit than CNG. Values for the present fuel quantity column 802-6 depend on the characteristics, the present fuel pressure and the present fuel temperature of the fuel in the tank 18.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed:

1. A multi-fuel system for a vehicle, comprising:
at least one fuel tank;
a first fuel receptacle configured to accept a first fuel;
at least a second fuel receptacle configured to accept a second fuel;
at least one sensor configured to detect fuel filling specific to each respective fuel receptacle;
at least one sensor configured to detect a quantity of the first fuel or the second fuel;
a fuel-agnostic engine configurable to selectively burn one or more of the first fuel and the second fuel; and
a fuel controller comprising a processor that executes instructions to:
determine an energy content of the first fuel in the at least one fuel tank;
determine an energy content of the second fuel in the at least one fuel tank;
determine a mass property of the first fuel in the at least one fuel tank from the sensed fuel fill;
determine a mass property of the second fuel in the at least one fuel tank from the sensed fuel fill;
determine fuel proportions of the first fuel and the second fuel in the at least one fuel tank based on the energy content and the mass property of the first fuel and the energy content and the mass property of the second fuel in the at least one fuel tank; and
supply at least one of the first fuel and the second fuel to the fuel-agnostic engine.

2. The multi-fuel system of claim 1, wherein:
a first tank of the at least one fuel tank stores a mixture of the first fuel and the second fuel;
a second fuel tank of the at least one fuel tank stores a single fuel; and
the processor executes the instructions to:
determine the fuel proportions of the first fuel and the second fuel in the first fuel tank based on the energy content and the mass property of the first fuel and the energy content and the mass property of the second fuel in the first fuel tank;
determine a quantity of the single fuel in the second fuel tank; and
supply the mixture of the first fuel and the second fuel, the second fuel, or a combination thereof to the fuel-agnostic engine.

3. The multi-fuel system of claim 1, further comprising a flow switch configured to measure flow rate of the first fuel or the second fuel into the at least one fuel tank, wherein the processor executes the instructions to determine one or more of the energy content and the mass property for the first fuel or the second fuel based on a measured flow rate of the first fuel or the second fuel through the flow switch.

4. The multi-fuel system of claim 3, further comprising a make switch coupled to the first fuel receptacle, wherein the make switch is configured to communicate a signal to the processor when an external fuel source is connected to the first fuel receptacle, wherein the processor executes the instructions to:
determine the first fuel is being added; and
determine one or more of the energy content and the mass property for the first fuel based on a measured flow rate of the first fuel through the flow switch.

5. The multi-fuel system of claim 1, wherein the fuel controller processor executes instructions to:
determine a route associated with the vehicle;
determine a plurality of segments for the route;
determine a performance plan for the vehicle for at least one segment of the plurality of segments; and
communicate the performance plan to the vehicle, the performance plan comprising a set of drivetrain configuration instructions to operate a drivetrain of the vehicle for the at least one segment of the plurality of segments, wherein the set of drivetrain configuration instructions includes an instruction to supply the first fuel, the second fuel, or a combination thereof to operate the engine over the at least one segment of the plurality of segments.

6. The multi-fuel system of claim 5, wherein:
the first fuel is associated with zero emissions; and
the processor executes the instructions to:
determine a present quantity of the first fuel;
determine a present quantity the second fuel;
determine that the drivetrain is not capable of operating the engine over the plurality of segments using only the present quantity of the first fuel;
determine that the drivetrain is not capable of operating the engine over the plurality of segments using only the present quantity of the second fuel;
determine the first set of segments includes at least one segment with an operating requirement for the vehicle to operate with zero emissions; and
communicate the performance plan to the vehicle, wherein the first set of drivetrain configuration instructions comprises a fuel instruction to supply the first fuel to the engine and an engine operation instruction to operate the engine in a first drivetrain configuration over each segment in the first set of segments.

7. The multi-fuel system of claim 5, wherein the fuel controller processor executes instructions to:
determine one or more of a performance of the engine, a location of the vehicle relative to a zero-emissions zone, a change in the route, traffic on the route or weather on the route; and
communicate an update to the performance plan comprising an updated set of drivetrain configuration instructions to operate the drivetrain of the vehicle for the at least one segment of the plurality of segments, wherein the updated set of drivetrain configuration instructions includes an instruction to supply the first fuel, the second fuel, or a combination thereof based on the performance of the engine, the location of the vehicle, the change in the route, the traffic on the route or the weather on the route.

8. The multi-fuel system of claim 6, wherein the processor executes the instructions to:
determine a first fuel present quantity of the first fuel;
determine a second fuel present quantity of the second fuel;
determine, for the route, a first set of segments for which operating the engine supplied with the first fuel will meet a first operating requirement;
determine, for the route, a second set of segments for which operating the engine supplied with the second fuel will meet a second operating requirement; and
the performance plan comprises:
a first set of drivetrain configuration instructions to supply the first fuel to the engine and operate the engine in a first drivetrain configuration over each segment in the first set of segments; and
a second set of drivetrain configuration instructions to supply the second fuel to the engine and operate the engine in a second drivetrain configuration over each segment in the second set of segments.

9. The multi-fuel system of claim 8, wherein:
the first fuel comprises a first gaseous fuel having a first fuel pressure between a first fuel minimum pressure and a first fuel maximum pressure;
the second fuel comprises a second gaseous fuel having a second fuel pressure between a second fuel minimum pressure and a second fuel maximum pressure;
the processor executes the instructions to:
determine the first fuel present quantity based on the first fuel pressure; and
determine the second fuel present quantity based on the second fuel pressure.

10. A method of supplying one or more fuels to support an engine operation comprising:
communicating with a sensor to determine a quantity of a fuel being added to a fuel system comprising a plurality of fuel tanks, the fuel being one of a first fuel or a second fuel;
communicating with a set of valves to route the fuel to a fuel tank of the plurality of fuel tanks;
determining an energy content of the first fuel in the at least one fuel tank;
determining an energy content of the second fuel in the at least one fuel tank;
determining a mass property of the first fuel in the at least one fuel tank from the sensed fuel fill;
determining a mass property of the second fuel in the at least one fuel tank from the sensed fuel fill;
determining fuel proportions of the first fuel and the second fuel in the at least one fuel tank based on the energy content and the mass property of the first fuel and the energy content and mass properties of the second fuel in the at least one fuel tank; and
supplying at least one of the first fuel and the second fuel to the fuel-agnostic engine.

11. The method of claim 10, wherein supplying at least one of the first fuel and the second fuel to the fuel-agnostic engine comprises communicating with one or more flow control valves to adjust flow of one or more of the first fuel and the second fuel based on at least one of the energy content of the first fuel and the energy content of the second fuel.

12. The method of claim 10, wherein supplying at least one of the first fuel and the second fuel to the fuel-agnostic engine comprises communicating with one or more flow control valves to adjust flow of one or more of the first fuel and the second fuel based on temperature feedback from the engine.

13. The method of claim 10, further comprising
determining the first fuel present quantity based on the first fuel pressure;
determining the second fuel present quantity based on the second fuel pressure;
determining the second fuel is associated with a lower operating cost of the vehicle;
determining that the drivetrain is not capable of operating the engine over the plurality of segments using only the first fuel present quantity;
determining that the drivetrain is not capable of operating the engine over the plurality of segments using only the second fuel present quantity;
determining the second set of segments does not include at least one segment with an operating requirement for the vehicle to operate with zero emissions; and
communicating the performance plan to the vehicle, wherein the second set of drivetrain configuration instructions comprises a fuel instruction to supply the second fuel to the engine and an engine operation instruction to operate the engine in a second drivetrain configuration over each segment in the second set of segments.

14. A method for controlling operation of a vehicle with a multi-fuel system, the method comprising:
determining a route associated with the vehicle;
determining a plurality of segments for the route;
determining a performance plan for the vehicle for at least one segment of the plurality of segments, comprising:
determining one or more characteristics of a first fuel in a first tank; and
determining one or more characteristics of a second fuel in the first tank or a second tank; and
communicating a performance plan to the vehicle, the performance plan comprising a set of drivetrain configuration instructions to operate the drivetrain of the vehicle for the at least one segment of the plurality of segments, wherein the set of drivetrain configuration instructions includes an instruction to supply the first fuel, the second fuel, or a combination thereof to the engine of the vehicle over the at least one segment of the plurality of segments.

15. The method of claim 14, further comprising:
determining a set of operating parameters of the vehicle corresponding to supplying the first fuel, the second fuel, or the combination thereof to the engine, the set of operating parameters comprising an emissions output, an engine efficiency, an engine output power, a motor efficiency for the M/G operating as a motor, a generator efficiency for the M/G operating as a generator, a battery state of charge (SOC), or a combination thereof;
determining a second set of values for the set of operating parameters of the vehicle corresponding to supplying the second fuel to the engine; and
comparing the first set of values to the second set of values to determine whether to supply the first fuel or the second fuel to the engine based on the operating requirement.

16. The method of claim 14, further comprising:
determining a first fuel present quantity of the first fuel;
determining a second fuel present quantity of the second fuel;
determining, for the route, a first set of segments for which operating the engine supplied with the first fuel will meet a first operating requirement;
determining, for the route, a second set of segments for which operating the engine supplied with the second fuel will meet a second operating requirement; and
determining the performance plan comprises:
determining a first set of drivetrain configuration instructions to supply the first fuel to the engine and operate the engine in a first drivetrain configuration over each segment in the first set of segments; and
determining a second set of drivetrain configuration instructions to supply the second fuel to the engine and operate the engine in a second drivetrain configuration over each segment in the second set of segments.

17. The method of claim 14, wherein:
the first fuel comprises a first gaseous fuel having a first fuel pressure between a first fuel minimum pressure and a first fuel maximum pressure;
the second fuel comprises a second gaseous fuel having a second fuel pressure between a second fuel minimum pressure and a second fuel maximum pressure; and
determining the performance plan comprises:
determining the first fuel present quantity based on the first fuel pressure; and
determining the second fuel present quantity based on the second fuel pressure.

18. The method of claim 17, wherein:
the first fuel is associated with zero emissions;
determining the performance plan comprises:
determining the first fuel present quantity based on the first fuel pressure;
determining the second fuel present quantity based on the second fuel pressure;
determining that the drivetrain is not capable of operating the engine over the plurality of segments using only the first fuel present quantity;
determining that the drivetrain is not capable of operating the engine over the plurality of segments using only the second fuel present quantity; and
determining the first set of segments includes at least one segment with an operating requirement for the vehicle to operate with zero emissions,
wherein the first set of drivetrain configuration instructions comprises a fuel instruction to supply the first fuel to the engine and an engine operation instruction to operate the engine in a first drivetrain configuration over each segment in the first set of segments.

19. The method of claim 18, wherein determining the performance plan comprises:
determining the first fuel present quantity based on the first fuel pressure;
determining the second fuel present quantity based on the second fuel pressure;
determining the second fuel is associated with a lower operating cost of the vehicle;
determining that the drivetrain is not capable of operating the engine over the plurality of segments using only the first fuel present quantity;
determining that the drivetrain is not capable of operating the engine over the plurality of segments using only the second fuel present quantity;
determining the second set of segments does not include at least one segment with an operating requirement for the vehicle to operate with zero emissions,
wherein the second set of drivetrain configuration instructions comprises a fuel instruction to supply the second fuel to the engine and an engine operation instruction to operate the engine in a second drivetrain configuration over each segment in the second set of segments.

20. The method of claim 18, wherein the set of operating parameters comprises an emissions output, an engine efficiency, an engine output power, a motor efficiency for the M/G operating as a motor, a generator efficiency for the M/G operating as a generator, a battery state of charge (SOC), or a combination thereof.
